(19) United States
(12) Patent Application Publication
(10) Pub. No.: US 2022/0037921 A1
(43) Pub. Date: Feb. 3, 2022

(54) COMPACT SURVEILLANCE SYSTEM

(71) Applicant: Brendan Hyland, Edinburgh (GB)

(72) Inventor: Brendan Hyland, Edinburgh (GB)

(21) Appl. No.: 17/327,765

(22) Filed: May 24, 2021

Related U.S. Application Data
(60) Provisional application No. 63/060,141, filed on Aug. 3, 2020.

(51) Int. Cl. H02J 50/00; H02J 50/27

(52) U.S. Cl. CPC H02J 50/001; H04W 84/18; H02J 50/27

(57) ABSTRACT

A compact surveillance system (CSS) includes a power input configured to provide power to the system; one or more sensors configured to measure a measurand; a receiver configured to receive an external signal; and a processor configured to generate information, the processor being in electrical communication with: the one or more sensors; an information storage device configured to store the information; a transmitter unit configured to transfer the information; wherein the information is generated based on the measurand so as to reduce a transfer energy.

### TECHNICAL FIELD

The present disclosure relates to surveillance systems. In particular, the present disclosure relates to compact surveillance systems which are designed for energy efficiency.

### BACKGROUND

Surveillance is the monitoring of behaviour, activities, or information for the purpose of information gathering, influencing, managing or directing. This can include the use of sensors locate near to or at a distance from a life form, location, asset or equipment to be monitored. It can also include simple technical methods, such as human intelligence gathering and postal interception.

Surveillance systems are used in a wide number of applications including but limited to promote safety, security, health and wellbeing, to protect the environment, to enhance operational efficiency or to reduce costs. Typically, a surveillance system includes one or more sensors that are mounted in a location sought to be monitored. Data from sensors may be sent immediately by wired or wireless communications across a network to a monitoring system for real time monitoring by personnel and/or an automated or autonomous system. The sensor data may be processed at or near the sensors to derive information which is sent to a monitoring system which may be cloud based. Data that has been processed locally by algorithms may provide information used to improve the performance of other attributes of the surveillance system.

Surveillance systems suffer several drawbacks. One drawback is remote surveillance systems which are powered by a temporary source such as a battery and which use wireless communications suffer from the cost and operational complexity of battery replacement. The used working life of a battery-powered system is affected by the number of sensors used, sensor duty cycle, and the frequency of communications across a wireless network and the quantity of data transmitted and practical considerations of local recharging using solar or other means.

The energy efficiency of most systems is less than what might be desired, reducing the usefulness of such systems. Increasing the energy efficiency of surveillance systems, however, requires one or more of optimising sensor energy consumption, optimising sampling rate and optimising the quantity and frequency of information transfer. Such adjustments to sampling frequency and data transmission or information transfer may lead impact resolution and/or latency of the surveillance system.

The present disclosure has been devised to mitigate or overcome at least some of the above-mentioned problems.

### SUMMARY

In accordance with a first aspect of the present invention, there is provided a compact surveillance system (CSS) comprising: a power input configured to provide power to the system; one or more sensors configured to measure data from a measurand; a transducer unit configured to receive or link with an external signal; and a processor configured to generate information, the processor being in electrical communication with: the one or more sensors; an information storage device configured to store the information; a transducer unit configured to transfer the information; wherein the information is generated based on the measurand so as to reduce a transfer energy.

In the context of the present invention, the measurand may include but not limited to: above water, below water, below ground environments; infrastructure including but not limited to electrical cables, pipes, flowlines, cages, protection systems, foundations, bridges, roads, fixed and floating structures; buildings including but not limited to industrial, civic, and residential; below ground industrial processes; manned and unmanned vehicles; fauna and flora, including but not limited to humans, land, air and sea animals; environments including but not limited to underwater, underground, sea water, fresh water, above ground and above water.

The skilled person will understand that information is derived from data that has been processed, organised, structured or subject to interpretation by a computer algorithm to make the data meaningful or useful. Compressing data does not in itself result in information. Information provides context for data.

The present invention is especially useful for surveillance in environments which present information transfer challenges and with sensing apparatus which are required to function for a long time between maintenance events, or without any maintenance. This is typically the case for underwater surveillance, for example to monitor seismic activity. In this case, sensing apparatus must function reliably for an extended period of time, typically a number of years, without maintenance or the ability to replace or to recharge batteries through a mains-powered connection. Thus, it is vital for such a system to be energy efficient. Related to this, when measurement data or information derived therefrom is to be transferred through lossy mediums, for example through water, conventional apparatus may consume large amounts of power, requiring the use of large batteries if wired power connections are to be avoided. Thus, the present invention advantageously provides a reliable CSS which can operate and transfer measurement data or information derived therefrom with a high level of energy efficiency, thereby reducing wasteful energy consumption and a requirement to use large batteries.

The system may be fixed or mobile. The system may be wired or wireless. The system may comprise a low power receive or sink circuit having a limiting comparator with high gain configured to ensure each active power level has the same sensitivity. In some embodiments, the system comprises a secure passive monitoring system, wherein a minimum of two frequencies and a minimum of one tone length is detectable using a limiting comparator circuit for activation of the processor. In some embodiments, the system comprises a minimum of two frequency settings, each having a tone, wherein the tones are configured to be detected at each of the required frequencies using a limiting comparator circuit for activation of the processor. Preferably, a probability of false wake-up due to one or more of electromagnetic interference (EMI) and/or magnetic interference and unauthorised access reduces with the number of frequency settings. In some embodiments, the processor is configured to set and adapt a duty cycle to control the transfer of information using a minimum of two transfer methods. For example, the duty cycle may be adapted based on criteria other than signal quality, range or bandwidth.

In some embodiments, the system operates according to an adjustable energy setting. The energy setting provides a sensor duty cycle, a sensor energy, a pre-processing algorithm, a processing algorithm, a frequency, a transducer energy, a transducer gain, and a transducer bandwidth.

Preferably, the one or more sensors are one or more selected from the range of: a temperature sensor; a multi-frequency sensor; a location sensor; an Eddy Current corrosion sensor; a cathodic protection sensor; an ultrasonic thickness sensor; a pH sensor, a water density sensor; a turbidity sensor; a bio-fouling build-up sensor; a water conductivity sensor; a water salinity sensor; a water density sensor; a water current sensor; a strain sensor; a chemical composition sensor; an electromagnetic field sensor; a magnetic field sensor; a gravitational field sensor; a flow sensor; a flow velocity sensor; a speed-of-sound sensor; a speed-of-EM propagation sensor; a speed-of-magnetic field propagation sensor; a light sensor; a pressure sensor; and an image sensor. Accordingly, the processor is preferably operable to generate information such as: a speed-of-sound; a speed-of-EM field propagation; a speed-of-magnetic field propagation; a pH; a density; a conductivity; a salinity; a chemical composition; a velocity; a current; a biofouling; a turbidity; a location; an alignment; and a corrosion.

In some embodiments, the sensor is a low power sensor operable to measure the measurand at a lower sensitivity than a standard sensor. Advantageously, less power may be used. In some embodiments, the sensor may be a remote sensor configured to transfer measured data to the system, wherein the field strength at the surveillance system due to the 1/r component is greater than the field due to the 1/r² component and the field strength at the remote node due to the 1/r component is greater than the field due to the 1/r³ component.

In some embodiments, the processor generates the information based on the measurand using one or more selected from the range of: a data model; a digital twin; a machine learning algorithm; and an artificial intelligence algorithm. In some embodiments, the information is generated in order to maximise energy efficiency at the expense of latency. In some embodiments, the information is compressed by the processor. In alternative embodiments, the information is not compressed by the processor. In some embodiments, the processor is operable to execute a pre-processing algorithm configured to improve one or more of: energy efficiency; resilience; security; and latency for a given range. For example, the pre-processing algorithm may include one or more selected from the range of: data cleansing or cleaning; data editing; data wrangling; data de-duplication; data integration; data transformation; data reduction; data discretization; data sampling; and data resampling The information may comprise one or more selected from the range of: an image feature; a characteristic of the measurand; a development; a status; a health; a threshold; an alarm; a location; a movement; and a derived change of the measurand.

Preferably, the receiver unit comprises: a receiver transducer configured to convert the external signal into an electrical signal; a rectenna configured to convert electromagnetic energy of the external signal into electrical energy. Preferably, the rectenna is further configured to capture and convert ambient energy into electrical energy. The ambient energy may be one or more of an electromagnetic field, a magnetic field, an acoustic wave, and a temperature differential.

Preferably, the device further comprises an energy storage unit configured to store the electrical energy generated by the rectenna. The energy storage unit may comprise two or more accumulators for hybrid energy storage. For example, the accumulators may be one or more selected from the range of: a primary cell, a secondary cell, a capacitor, a supercapacitor, and an inductor. A size of the energy storage unit may be reduced due to the rectenna. This reduction in energy storage unit size leading to an improved compactness and a reduction in materials used for construction which brings benefits in the form of one or more of reduced environmental footprint, cost, and reliability.

In preferable embodiments, the receiver transducer is a smart transducer. Alternatively or additionally, the receiver transducer comprises one or more selected from the range of: impulsive interference suppression; software defined radio; adaptive radio; cognitive radio; and a cognitive radio sensor network. In this way, a communications link energy efficiency and performance, resilience, and compactness of the system may improve. Additionally or alternatively, the receiver transducer may comprise one or more selected from the range of: an antenna; an intelligent antenna; a loop antenna; a photodetector; a photoresistor; a phototransistor; and a photomultiplier.

Preferably, the device further comprises a data storage device configured to store the measurand.

Preferably, the transmitter unit comprises: a transmitter having a modulator configured to modulate the information on to a carrier signal; and a transmitter transducer configured to produce and radiate an electromagnetic wave comprising the modulated signal. In some embodiments, the transmitter transducer is a smart transducer. The smart transducer may comprise a shield configured to reduce interference due to an electromagnetic field. Additionally or alternatively, the smart transducer may comprise: a transmit loop antenna with a minimum of one of a maximum of 2 turns, and manufactured of low resistance and electrically insulated tube, and resonated, and maintained in resonance by varying a minimum of one of power and frequency and capacitance and signal processing. Additionally or alternatively, the transmitter may comprise one or more selected from the range of: a loosely coupled transformer, an acoustic transmitter, an optical transmitter, a radio transmitter, a cognitive radio transmitter; and a magneto-inductive transmitter. Additionally or alternatively, the transmitter may comprise one or more selected from the range of: an antenna; an intelligent antenna; a loop antenna; a photodetector; a photoresistor; a phototransistors; and a photomultiplier.

The transmitter may comprise an antenna. Alternatively, the transmitter may comprise a coil transducer.

In some embodiments, the system further comprises a data input configured to receive external data from an external source. Accordingly, the system may be attached to a communications cable configured to provide data to the system.

Preferably, the processor generates the information based on the measured data and the external data.

In some embodiments, the one or more sensors each comprise a processor having logic configured to determine a parameter of the measurand.

In some embodiments, the system comprises a supercapacitor. The supercapacitor may advantageously improve link performance

In some embodiments, the processor is operable to perform one or more selected from the range of: encryption; data masking; data erasure; data resilience; data authentication not limited to digital ledger and blockchain and volatile memory and traps and self-destruct fuse and auto-destruct fuse and biodegradable materials and chemical release and honeypot techniques.

In some embodiments, the system comprises a Loosely Coupled Transformer (LCT) including a supercapacitor, a source transducer including a resonant primary coil, a sink transducer including a resonant secondary coil and a rekoil, sink incorporating impulsive interference suppression, at least one of a source transducer and sink transducer is located in a fluid propagating medium, wherein a minimum of one of power and information is transferred from source to a remote sink. The skilled person will understand that the term “rekoil” means a rectifier-coil transducer, which converts induction field to energy for use by the sink. This may improve energy efficiency of the system.

In accordance with a second aspect of the present invention, there is provided a network comprising: a first CSS having a first receiver and a first transmitter, the first transmitter configured to transfer an electromagnetic signal comprising information; and a second CSS having a second receiver and a second transmitter, the second transmitter configured to receive the electromagnetic signal, wherein at least one CSS is at least partially submerged in a fluid propagating medium; wherein the first transmitter and the second receiver are operable to communicate within a far field of said electromagnetic signal, said far field corresponding to the region around the transmitter; and wherein a field strength of the electromagnetic signal at an inverse distance (1/r) is greater than the field strength at an inverse distance squared (1/r²) and an inverse distance cubed (1/r³).

In alternative embodiments, the first transmitter and the second receiver are operable to communicate within near field, said near field of said electromagnetic signal corresponding to a region around the first transmitter where the field strength corresponds to e^{ar} where α is a correction term.

In some embodiments, the network is asymmetric. For example, the network may comprise a primary/secondary system, a source/replica system, or a provider/consumer system.

In some embodiments, the network further comprises a third CSS.

In some embodiments, the network is configured as an edge computing network. In alternative embodiments, the network is configured as a hybrid cloud network.

In some embodiments, the network is configured as an information network such that information is transferred from the first system to the second system, and the second system modifies the information. The information may be modified by removal of a part of the information and/or addition of information from the second system. The modified information may be transferred from the second system to the third system.

In some embodiments, the network is a cabled network. configured to transfer information preferably over a low bandwidth information network and preferably using one or more of LCT and radio and Magneto-Inductive (MI).

In some embodiments, each system is configured to communicate with a maximum of two other systems. Preferably, one or more of a watchdog timer; a time synchronisation system; and/or a token verification system are used to confirm a failure of the link. Preferably, where a failure has been confirmed, a new configuration is established with a further system based on one or more of: an energy efficiency; a reliability; and a security.

In some embodiments, the first and second systems are attached to a subsea structure above a seabed, and a third system is attached to the subsea structure below the seabed. The attachment may be via an attachment mechanism such as: a magnetic clamp, a suction cup, a strap, a snap bracelet, a Velcro, a hinged clamp, a glue, a weld, and a fastener. Preferably, a field strength of each inter-system link is measured by the respective sensor, the field strength is compared at one or more frequencies, data is derived and processed to calculate the location of the seabed, and the information describing a minimum of one of the extent and rate of and variability of seabed scouring is transferred to a monitoring system.

### BRIEF DESCRIPTION OF THE DRAWINGS

FIG. 1 is a compact surveillance system according to a first aspect of the present invention.

FIG. 2 is a network of compact surveillance systems of FIG. 1, according to a second aspect of the present invention.

FIG. 3 is a further network of compact surveillance systems.

FIG. 4 is a further network of compact surveillance systems.

FIG. 5 is a further network of compact surveillance systems.

FIG. 6 is a further network of compact surveillance systems.

FIG. 7 is a further network of compact surveillance systems.

### DETAILED DESCRIPTION

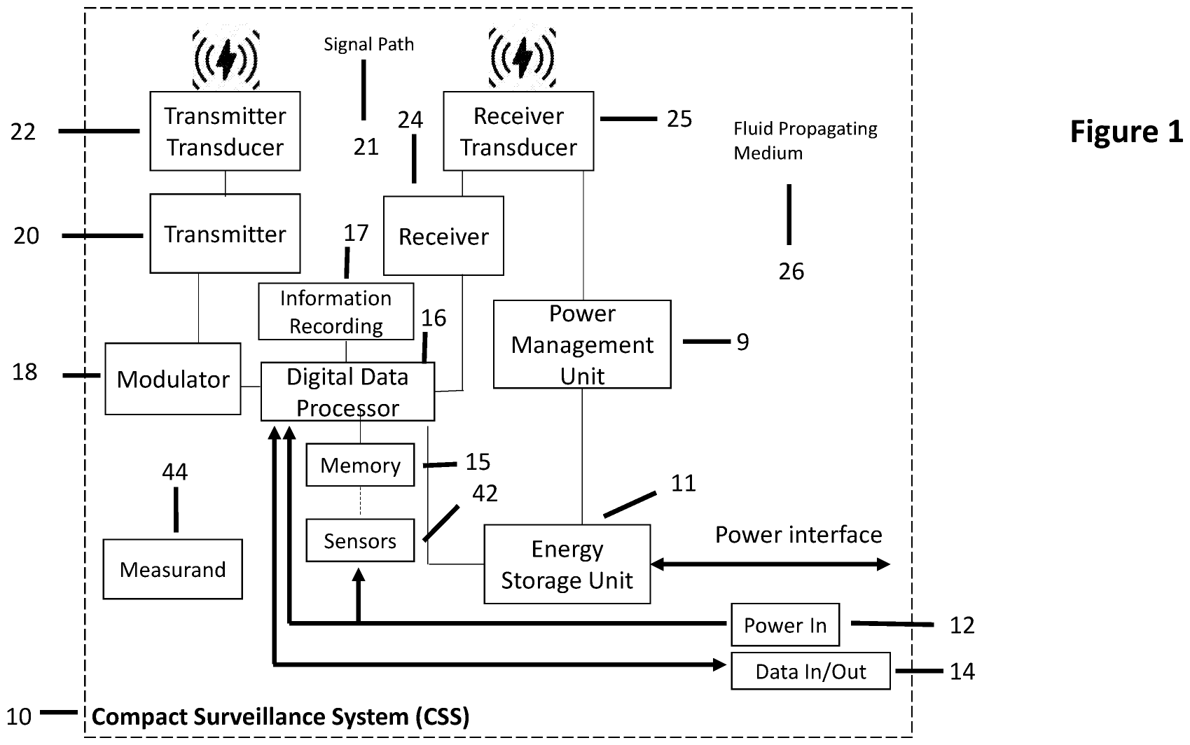

FIG. 1 shows a compact surveillance system (CSS) 10. The CSS 10 includes: a power input 12; a sensor 42; a data input 14; a data memory storage 15; a processor 16, an information storage device 17; a modulator 18, a transmitter transducer 22; and a receiver transducer 25.

The sensor 42 is configured to measure a measurand 44. In the present example, the sensor comprises two temperature gradient sensors 42 configured to provide a signal indicative of a temperature and/or temperature gradient.

The processor 16 is in electrical communication with: the data input 14; the data memory storage 15; the modulator 18; the information storage device 17; and the receiver transducer 25. The processor 16 is configured to receive measurand data from the sensor. The processor 16 is also operable to pre-process and process the data into information. The processor 16 stores the information on the information storage device 17 and generates an information signal representative of the information. For example, the processor 16 is configured to derive one or more selected from the range of: a thermal gradient; a temperature time constant; and a thermal properties of the measurand. The information signal is communicated to the modulator 18.

The modulator 18 is in electrical communication with the processor 16 and the transmitter transducer 22. The modulator 18 is configured to receive the information signal generated by the processor 16. The modulator 18 is also configured to superimpose the information signal on to a carrier signal, and the modulated signal is subsequently communicated to the transmitter transducer 22.

The transmitter transducer 22 is in electrical communication with the modulator 18. The transmitter transducer 22 is configured to receive the modulated signal and convert the modulated signal into an electromagnetic wave for transferring to a remote device (not shown). In alternative embodiments, the transmitter transducer may convert the modulated signal into a magneto-inductive signal.

The receiver transducer 25 is in electrical communication with the processor 16. The receiver transducer 25 comprises an intelligent antenna. The receiver transducer 25 is configured to receive an external signal from an external source (not shown).

The CSS 10 is at least partially submerged in a fluid propagating medium 26 such that the receiver transducer 25 is submerged in the fluid propagating medium 26. A signal path between the transmitter transducer 22 and the receiver transducer 25 at least partially traverses the fluid propagating medium.

The CSS 10 further comprises an energy harvesting module. In particular, the CSS 10 further comprises a power management unit 9 and an energy storage unit 11. The receive transducer 25 comprises a rectenna, said rectenna being in electrical communication with the power management unit 9. The rectenna is configured to convert electromagnetic energy of the external signal into energy. The energy storage unit 11 is a battery configured to store energy from the rectenna, and release said energy to the CSS 10. The power management unit 9 is a microcontroller configured to govern power functions. For example, the power management unit 9 measures a voltage and/or a discharge and recharge time of the energy storage unit. The power management unit 9 controls power functions, and regulates a real time clock.

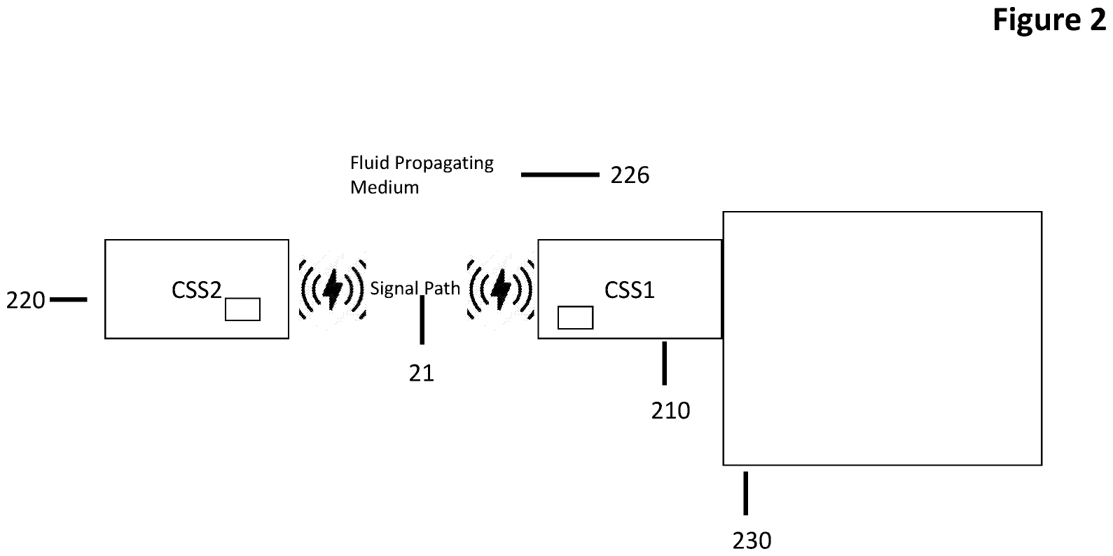

FIG. 2 is a network of compact surveillance systems comprising a first CSS 210 and a second CSS 220. The first CSS 210 and the second CSS 220 are substantially similar to the CSS 110. The first CSS 210 is integrated with an underwater vehicle 230, submerged in a fluid propagating medium 226, such as water.

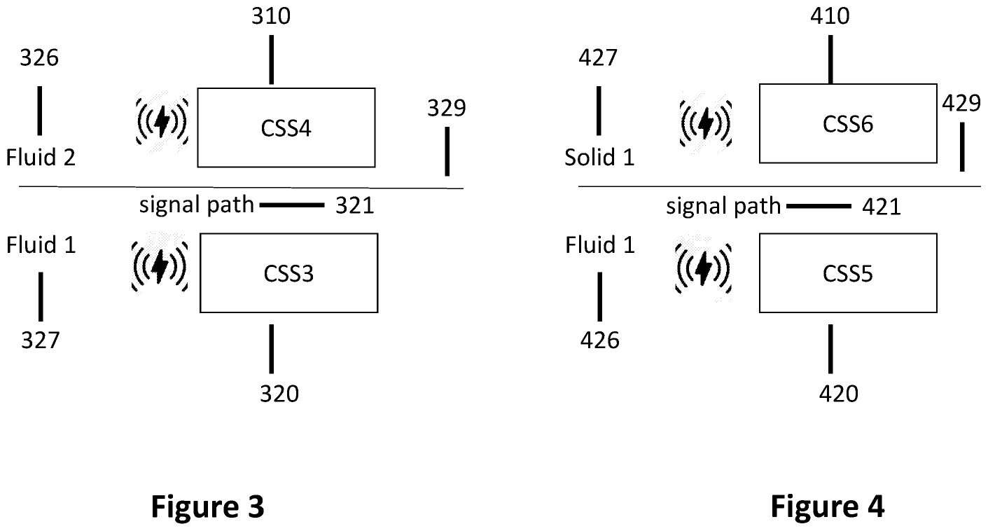

FIG. 3 is a network of compact surveillance systems comprising a first CSS 310 and a second CSS 320. The first CSS 310 and the second CSS 320 are substantially similar to the CSS 10. The first CSS 310 is submerged in a first fluid propagating medium 326, such as water. The second CSS 320 is submerged in a second fluid propagating medium 327. The first fluid propagating medium 326 and the second fluid propagating medium 327 are separated by a fluid boundary 329. The respective transducers of the first CSS 310 and the second CSS 320 are configured such that an electromagnetic signal 321 transmitted by a transmitter transducer of the first CSS 310 traverses the boundary 329 and is received by the receiver transducer of the second CSS 320. Additionally, the first CSS 310 and the second CSS 320 are positioned such that a field strength of the electromagnetic signal received at the receiver transducer of the second CSS 320 at an inverse distance (1/r) is greater than the field strength at an inverse distance squared (1/r²) and an inverse distance cubed (1/r³).

FIG. 4 is a network of compact surveillance systems comprising a first CSS 410 and a second CSS 420. The first CSS 410 and the second CSS 420 are substantially similar to the CSS 10. The first CSS 410 is submerged in a first fluid propagating medium 426, such as water. The second CSS 420 is located in or on a solid propagating medium 427. The first fluid propagating medium 426 and the solid propagating medium 427 are separated by a solid boundary 429. The respective transducers of the first CSS 410 and the second CSS 420 are configured such that an electromagnetic signal 421 traverses the solid boundary 429. Additionally, the first CSS 410 and the second CSS 420 are positioned such that a field strength of the electromagnetic signal received at the receiver transducer of the second CSS 420 at an inverse distance (1/r) is greater than the field strength at an inverse distance squared (1/r²) and an inverse distance cubed (1/r³).

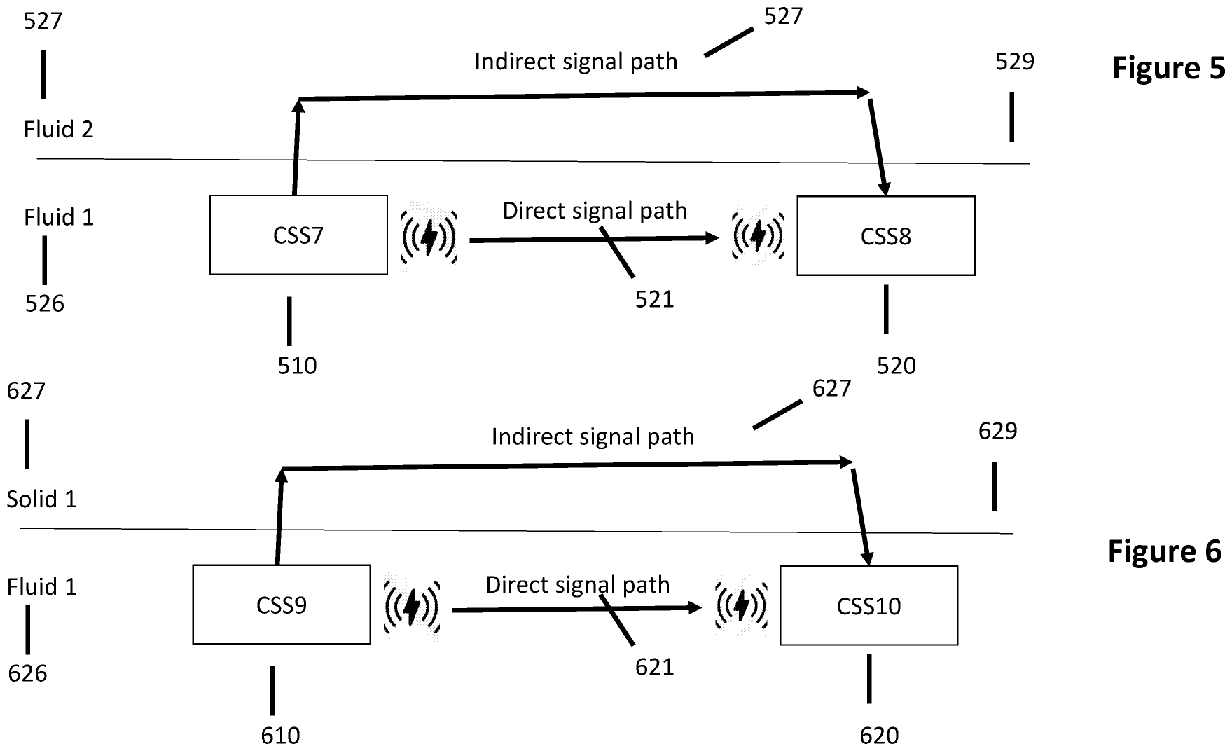

FIG. 5 is a network of compact surveillance systems comprising a first CSS 510 and a second CSS 520. The first CSS 510 and the second CSS 520 are substantially similar to the CSS 10. The first CSS 510 and the second CSS 520 are both submerged in a first fluid propagating medium 526, such as water. A fluid-fluid boundary 529 separates the first fluid propagating medium 526 from a second fluid propagating medium 527. The respective transducers of the first CSS 510 and the second CSS 520 are configured such that an electromagnetic signal 521 transmitted by a transmitter transducer of the first CSS 510 is transmitted directly or indirectly. In the direct transmission case, the signal 521 traverses the first medium 526. In the indirect transmission case, the signal 521 traverses the fluid boundary 529, propagates through the second medium 529, and traverses the fluid boundary 529 from the second medium 529 to the first medium 526.

FIG. 6 is a network of compact surveillance systems comprising a first CSS 610 and a second CSS 620. The first CSS 610 and the second CSS 620 are substantially similar to the CSS 10. The first CSS 610 and the second CSS 620 are both submerged in a fluid propagating medium 626, such as water. A fluid-solid boundary 629 separates the fluid propagating medium 626 from a solid propagating medium 627. The respective transducers of the first CSS 610 and the second CSS 620 are configured such that an electromagnetic signal 621, 627 transmitted by a transmitter transducer of the first CSS 610 is transmitted directly or indirectly. In the direct transmission case, the direct signal 521 traverses the first medium 626. In the indirect transmission case, the indirect signal 627 traverses the fluid boundary 629, propagates through the second medium 629, and traverses the fluid boundary 629 from the second medium 629 to the first medium 626. Additionally, the first CSS 610 and the second CSS 620 are positioned such that a field strength of the electromagnetic signal received at the receiver transducer of the second CSS 620 at an inverse distance (1/r) is greater than the field strength at an inverse distance squared (1/r²) and an inverse distance cubed (1/r³). The indirect transmission path 621 is longer than the direct transmission path 627. Transferring through the boundary 629 is sub-optimal.

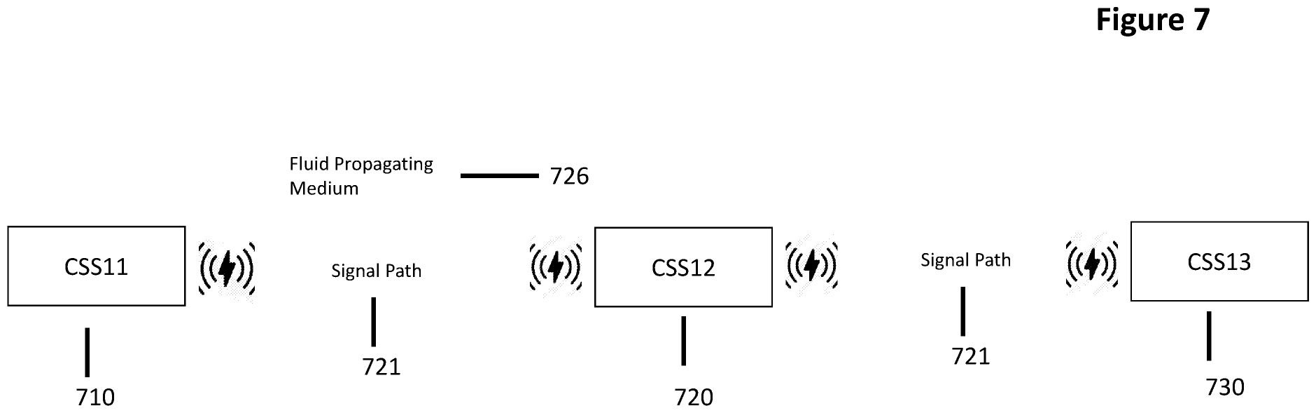

FIG. 7 is a network of compact surveillance systems comprising a first CSS 710, a second CSS 720, and a third CSS 720 submerged in a fluid propagating medium 726. The first CSS 710, the second CSS 720, and the third CSS 730 are substantially similar to the CSS 10. The first CSS 710 transfers a first information to the second CSS 720. The second CSS 720 modifies, via its processor, the first information so as to include additional information. The second CSS 720 transfers a second information, comprising the first information and the additional information, to the third CSS 730.

The above-mentioned compact surveillance system and networks find particular, but not limited use in offshore structure surveillance and holistic companion animal care.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A compact surveillance system (CSS) comprising:
a power input configured to provide power to the system;
one or more sensors configured to measure a measurand;
a receiver configured to receive an external signal; and
a processor configured to generate information, the processor being in electrical communication with:
the one or more sensors;
an information storage device configured to store the information;
a transmitter unit configured to transfer the information;
wherein the information is generated based on the measurand so as to reduce a transfer energy.

2. The system of claim 1, wherein the receiver comprises:
a receiver transducer configured to convert the external signal into an electrical signal;
a rectenna configured to convert electromagnetic energy of the external signal into electrical energy.

3. The system of claim 2, wherein the rectenna is further configured to capture and convert ambient energy into electrical energy.

4. The system of claim 3, wherein the device further comprises an energy storage unit configured to store the electrical energy captured by the rectenna.

5. The system of any preceding claim, wherein the receiver transducer is a smart transducer.

6. The system of any preceding claim, wherein the transmitter unit comprises:
a transmitting having a modulator configured to modulate the information on to a carrier signal;
a transmitter transducer configured to produce and radiate an electromagnetic wave comprising the modulated signal.

7. The system of any preceding claim, wherein the device further comprises a data storage device configured to store the measurement.

8. The system of any preceding claim, further comprising a data input configured to receive external data from an external source.

9. The system of any preceding claim, wherein the processor generates the information based on the environmental data and the external data.

10. The system of any preceding claim, wherein the one or more sensors each comprise a processor having logic configured to determine a parameter of the measurand.

11. A network comprising:
a first CSS having a first receiver and a first transmitter, the first transmitter configured to transfer an electromagnetic signal comprising information; and
a second CSS having a second receiver and a second transmitter, the second transmitter configured to receive the electromagnetic signal,
wherein at least one CSS is at least partially submerged in a fluid propagating medium;
wherein the first transmitter and the second receiver are operable to communicate within a far field of said electromagnetic signal, said far field corresponding to the region around the transmitter; and
wherein a field strength of the electromagnetic signal at an inverse distance (1/r) is greater than the field strength at an inverse distance squared (1/r²) and an inverse distance cubed (1/r³).

12. The system of claim 11, wherein the network further comprises a third CSS having a third receiver and a third transmitter.

13. The system of claim 12, wherein the first CSS is configured to transfer a first information to the second CSS and the second CSS is configured to transfer modified information to the third CSS.

14. The system of claim 13, wherein the modified information is generated by the second CSS, wherein the modified information comprises the first information and an additional information.
